(19) United States
(12) Patent Application Publication
(10) Pub. No.: US 2018/0283338 A1
(43) Pub. Date: Oct. 4, 2018

(54) INJECTOR FOR INTRODUCING A FLUID WITH IMPROVED JET PREPARATION

(71) Applicant: Robert Bosch GmbH, Stuttgart (DE)

(72) Inventors: Jens Soerensen, Ludwigsburg (DE); Lars Opfer, Ludwigsburg (DE); Peter Keck, Weissach-Flacht (DE); Philipp Rogler, Stuttgart (DE); Tobias Knorsch, Schwieberdingen (DE)

(21) Appl. No.: 15/943,378

(22) Filed: Apr. 2, 2018

(30) Foreign Application Priority Data
Apr. 4, 2017 (DE) 10 2017 205 665.7

(51) Int. Cl. F02M 61/18

(52) U.S. Cl. CPC F02M 61/1806; F02M 2200/06; F02M 61/1853

(57) ABSTRACT

An injector for injecting a fluid, in particular for injecting fuel, includes at least one closing element for opening and closing at least one through opening. The through opening includes an injection hole having a first center axis, and a preliminary stage having a second center axis. The first center axis of the injection hole and the second center axis of the preliminary stage of at least one of the through openings diverge.

### RELATED APPLICATION INFORMATION

The present application claims priority to and the benefit of German patent application no. 10 2017 205 665.7, which was filed in Germany on Apr. 4, 2017, the disclosure which is incorporated herein by reference.

### FIELD OF THE INVENTION

The present invention relates to an injector for introducing a fluid, in particular a fuel, into a combustion chamber with improved jet preparation at the nozzle outlet.

### BACKGROUND INFORMATION

Injectors for introducing fluids, for example as fuel injectors for injecting liquid fuel or for blowing in a gaseous fuel, are known from the related art in different embodiments, and are typically used for directly injecting fuel into the combustion chamber. These types of injectors are known from DE 10 2013 220 836 A1, for example, and are typically made up of a housing in which a pressure chamber is incorporated. A closing element that cooperates with a closing element seat, mounted in the housing, during a lateral movement is situated so that it is movable along a longitudinal axis of the pressure chamber. For introducing the fuel into the combustion chamber, the closing element thus opens and closes one or multiple through openings incorporated in the housing or in the closing element seat as a function of the position of the closing element. For this purpose, the fuel is highly pressurized in the pressure chamber, so that the fuel is atomized when it exits from the through opening and enters the combustion chamber. The through openings are often configured with an injection hole and one or multiple preliminary stages which expand the diameter of the through opening one or more times in a stepped manner, and which are conventionally used for setting the effective injection hole length and protecting the actual injection hole from coking.

The flow through the through openings is often very faulty due to turbulence, manufacturing tolerances, and different targeting orientations of the through openings. As a result, flow separation and high cavitation rates are present at the inlet edge of the through opening, resulting in a more or less strongly pronounced hole filling on one side, which has an adverse effect on the air intake into the jet, the spray dispersion, the penetration depth, and the wetting.

### SUMMARY OF THE INVENTION

The injector according to the present invention for introducing a fluid, in particular a fuel, having the features described herein has the advantage over the related art that the jet preparation of the injector is improved. In particular, the dome wetting and the penetration of the fuel jet may be reduced, and the dispersion of the fuel jet in the radial direction may be increased with avoidance of a one-sided jet constriction at the preliminary stage wall. This is achieved according to the present invention in that for injection of a fluid, in particular for the direct injection of fuel, the injector includes at least one closing element for opening and closing at least one through opening, the through opening including an injection hole having a first center axis, and a preliminary stage having a second center axis, the first center axis of the injection hole and the second center axis of the preliminary stage diverging. The injection hole and the preliminary stage thus do not have a shared center axis. This noncoaxial arrangement of the first center axis and the second center axis is configured in such a way that the center of mass and/or of volume of the liquid phase of the fuel jet exiting from the injection hole may be situated coaxially on the second center axis of the preliminary stage. Due to the exemplary coaxial arrangement of the jet center of mass and/or volume on the second center axis, the jet preparation is greatly improved, and thus the penetration of the fuel spray is reduced, and the fuel dispersion, in particular in the radial direction from the second center axis, is increased, and the dome wetting and penetration of the fuel are reduced.

The further descriptions herein set forth further exemplary refinements of the present invention.

The first center axis and the second center axis may be situated in parallel and spaced apart from one another, so that, due to the distance between the two axes, the interaction between the jet exiting from the injection hole and the subsequent preliminary stage may be set over the entire circumference. The first and second center axes are thus situated eccentrically with respect to one another. Namely, the interaction of the jet with the preliminary stage affects the effective hole length, and thus has a direct influence on the jet preparation. For a cylindrical shape of the injection hole and of the preliminary stage, the maximum distance between the first axis and the second axis in the transition from the injection hole to the preliminary stage may correspond to the difference between the radius of the preliminary stage and the radius of the injection hole.

In addition, the second center axis may be situated at an angle with respect to the first center axis of the injection hole, so that the jet exiting from the injection hole or its center of mass is situated on the second center axis of the preliminary stage. The length of the injection hole often is not sufficient to orient the occurring flow in such a way that it flows into the preliminary stage in parallel to the first center axis. The angle between the first and the second center axes compensates for this so-called incidence, so that the jet is uniformly influenced by this incidence over the entire length along the preliminary stage. In particular, the jet dispersion in the radial direction as well as the distribution of the fuel spray in the combustion chamber are particularly uniform due to this measure. The first and the second center axes are often situated in two different planes. However, it is also particularly advantageous when the first and the second center axes have an intersection point that is situated within the through opening.

According to another exemplary embodiment of the present invention, the preliminary stage is situated behind the injection hole, in the flow direction of the fuel in the through opening. The jet exiting from the injection hole thus undergoes an abrupt cross-sectional enlargement through the preliminary stage, and as the result of friction processes, pulse equalization, and pressure differences within the jet, a so-called entrainment flow may form, via which air from the surroundings is guided into and onto the jet to form the spray. Due to the vortical flow, this flow results in re-aspiration of fuel that is deposited on the dome, thus improving the self-cleaning effect and the protection from coking.

To provide a particularly compact design and to shorten the effective length of the injection hole, length L1 of the injection hole may be dimensioned to be shorter than length L2 of the preliminary stage.

The through openings in the housing of the injector may be situated in an injection hole disk. The injection hole disk may be fixedly coupled to the housing in a liquid- and gas-tight manner, for example with the aid of a form-fit and/or force-fit connection, and allows the change of an injection hole configuration of the injector and simplifies its customization. In addition, the injection hole disk typically has simple geometric dimensions, which allows a cost-effective manufacture due to good accessibility of the injection holes.

According to another exemplary embodiment of the present invention, the preliminary stage is formed from at least one cross-sectional enlargement, so that the area of the preliminary stage is dimensioned to be greater than the area of the injection hole through which flow passes. Area ratios of the area of the preliminary stage to the area of the injection hole particularly may be 1:1.3 to 1:12, in particular 1:1.3 to 1:3.0.

In addition, it particularly may be provided that the center of mass of the jet may be situated at the end of the injection hole, on the second center axis of the preliminary stage. A particularly homogeneous interaction between the jet and the preliminary stage is thus produced, since the jet axis, i.e., the axis on the point of the center of mass of the jet, extends coaxially with respect to the second axis, and the preliminary stage circumferentially symmetrically influences the jet.

The injector may include at least one flow pocket in the pressure chamber, situated in the area of the closing element seat. The flow pocket corresponds to a pocket or groove provided in the inner wall of the pressure chamber, which increases the effective flow cross section. In addition, at least one web may be integrally molded or incorporated in the area of the closing seat, which provides linear guiding for the valve ball in the manner of a slide bearing. The enlargement of the effective flow cross section in the area of the closing element seat increases the flow rate through the sealing seat in the open position of the injector, and in particular allows a constant outflow rate/injection rate over a plurality of cycles, independently of the mass of fuel that is expelled in a cycle.

According to another exemplary embodiment of the present invention, the length of the injection hole in the flow direction is dimensioned to be smaller than the length of the preliminary stage. The length of the preliminary stage allows in particular a further dispersion of the spray in the radial direction, due to an increase in the effective channel cross section.

In addition, it may be provided that the injection hole and/or the preliminary stage have/has a cylindrical, concave, or convex shape, as the result of which the shape of the flow channel influences the shape of the jet exiting from the injection hole in a targeted manner. The penetration and the jet separation angle of the spray may be set by this shape of the flow channel. It particularly may be that the preliminary stage itself also includes at least one gradation.

Exemplary embodiments of the present invention are described in greater detail below with reference to the appended drawings. Identical or functionally equivalent parts are denoted by the same reference numerals in the drawings.

### BRIEF DESCRIPTION OF THE DRAWINGS

FIG. 1 shows a schematic side view of an injector according to a first exemplary embodiment of the present invention.

FIG. 2 shows a schematic, enlarged partial sectional view of the injector according to FIG. 1.

FIG. 3 shows a schematic, enlarged partial sectional view of the injector along section line Y-Y according to FIG. 2.

FIG. 4 shows a schematic detailed view of a through opening of the injector according to the first exemplary embodiment of the present invention.

FIG. 5 shows a schematic detailed view according to a second exemplary embodiment of the present invention.

### DETAILED DESCRIPTION

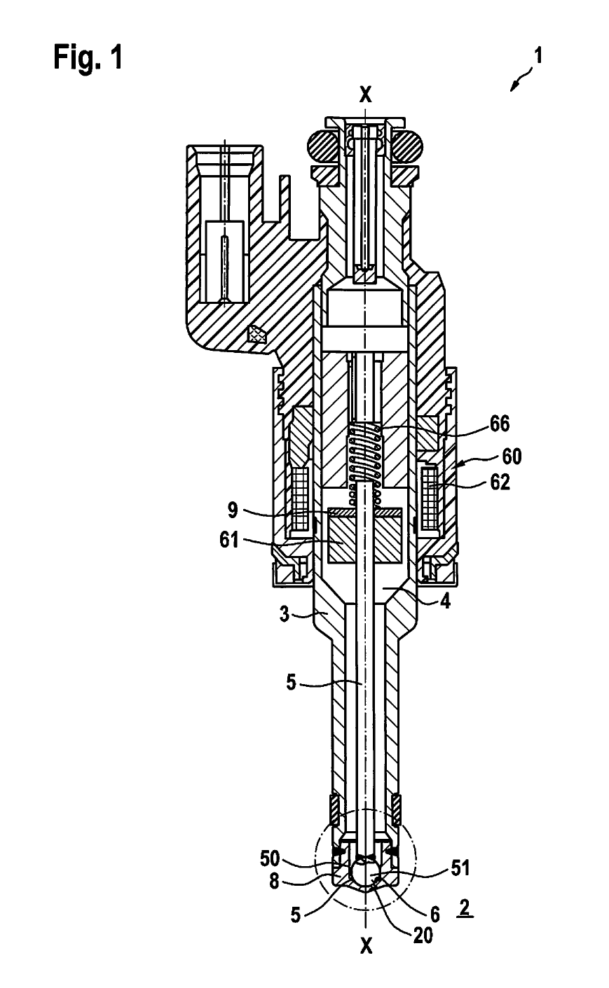

A fuel injector according to a first exemplary embodiment of the present invention is described in greater detail below with reference to FIGS. 1 through 4.

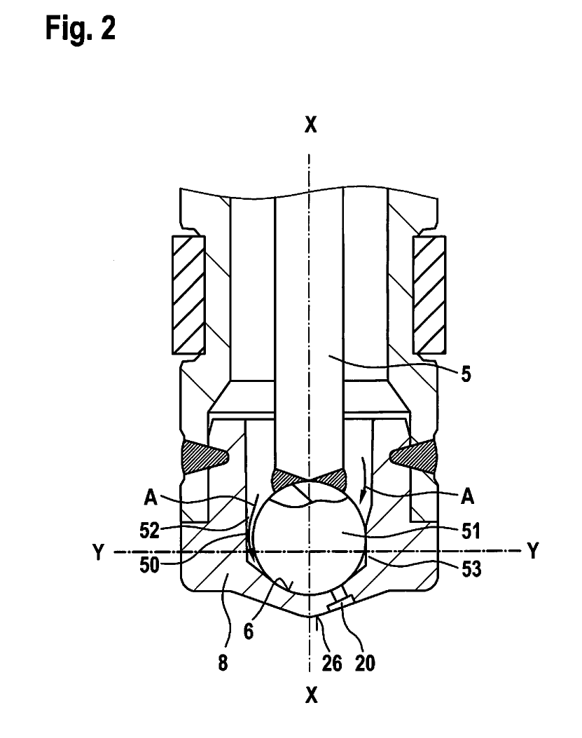

As is apparent from FIG. 1, injector 1 includes a housing 3, an actuator 60, and a closing element 5 in the form of a valve needle. Closing element 5 opens up and closes a through opening 20 in housing 3 or, as shown in FIG. 2, in an injection hole disk 8 fixedly situated in housing 3. FIGS. 1 and 2 show the closed state of injector 1.

Injector 1 is an inwardly opening injector 1, the opening direction being opposite outflow direction A from injector 1.

Actuator 60 is a magnetic actuator, and includes an armature 61 and a coil 62. Closing element 5 is movable in axial direction X-X due to the cooperation of actuator 60 and armature 61. A resetting element 66 holds closing element 5 in the closed position shown in FIGS. 1 and 2. It is self-evident that actuator 60 may also be configured as a piezo actuator.

Injector 1 also includes a pressure chamber 4 that encompasses the interior of housing 3. Pressure chamber 4 is filled with fluid or fuel 10 to be introduced. A high pressure which may be up to 350×10⁵ Pa prevails in pressure chamber 4, depending on the medium to be introduced.

Closing element 5 is apparent in greater detail in FIG. 2. Closing element 5 is configured as a valve needle with a valve ball 51 and a stop 55. In addition, housing 3 is provided with a supply line area 50 that extends in axial direction X-X of injector 1 from a closing element seat 6, opposite outflow direction A, along longitudinal axis X-X. Supply line area 50 together with closing element 5 forms an annular space that is part of pressure chamber 4, through which fuel 10 is guided to closing element seat 6 in outflow direction A.

Injector 1 is situated directly at a combustion chamber 2, and may be configured as a fuel injector 1 for the direct injection of fuel 10. However, fuel 10 may be gaseous or liquid.

Injector 1 according to the first exemplary embodiment functions as follows. When an opening operation is initiated, an actuator force is exerted on armature 60 by actuator 61, so that armature 60 together with closing element 5 is moved linearly in axial direction X-X, opposite outflow direction A.

Due to the movement of closing element 5, which takes place opposite the elastic force of resetting element 66, an annular space between valve ball 51 and closing element seat 6 is opened, and fuel 10 flows through this annular space into an inflow area 7. Inflow area 7 conducts fuel 10 to a through opening 20, through which fuel 10 is conducted from pressure chamber 4 into combustion chamber 2. In the idle state of injector 1 illustrated in FIGS. 1 and 2, valve ball 51 is pressed against closing element seat 6 due to the elastic force of resetting element 66, so that inflow area 7 may be closed off or separated from the remaining pressure chamber 4 in a gas- and fluid-tight manner. For this purpose, the shape of closing element seat 6 is adapted to the shape of valve ball 51.

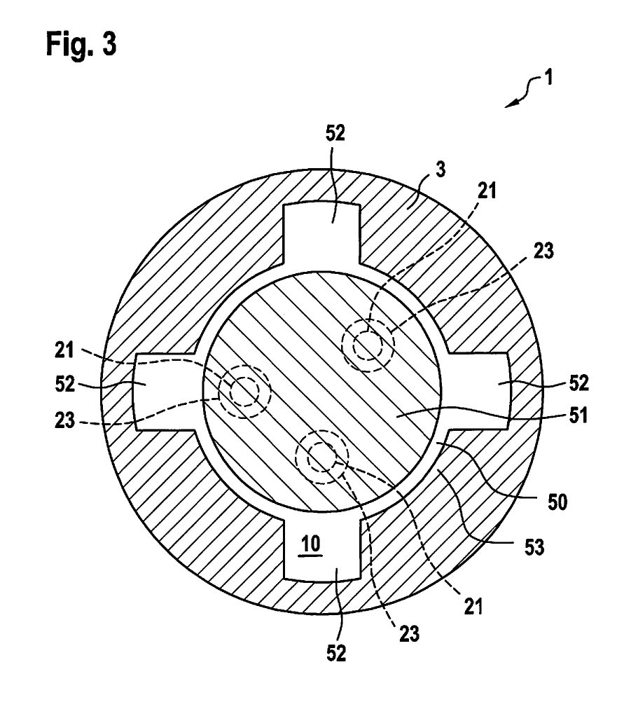

FIG. 3 shows a section of injector 1 according to FIG. 2 along a plane in section line Y-Y. Multiple flow pockets 52 and webs 53 are situated in housing 3 over the circumference. Flow pockets 52 increase the effective cross section through which flow passes in axial direction X-X of injector 1 in the area of supply line area 50, so that fuel 10 may flow quickly and with low pressure loss through this cross-sectional enlargement and into inflow area 7, and thus into through opening 20. For this purpose, flow pockets 52 may be provided in housing 3, so that one or multiple webs 53 is/are formed between flow pockets 52. Webs 53 form bearing surfaces and guide surfaces for valve ball 51 or closing element 5, and support it in the radial direction. Flow pockets 52 and webs 53 accordingly extend from closing element seat 6 in axial direction X-X of injector 1, which may be over an entire stroke distance which valve ball 51 traverses during opening and closing.

Through openings 20 are provided over the circumference in inflow area 7 and in housing 3 corresponding to the angular pitch of flow pockets 52, so that the circumferential positions of flow pockets 52 and of through openings 20 correspond.

Through openings 20 may be positioned, independently of one another, relative to flow pockets 52 as a function of the number of through openings 20.

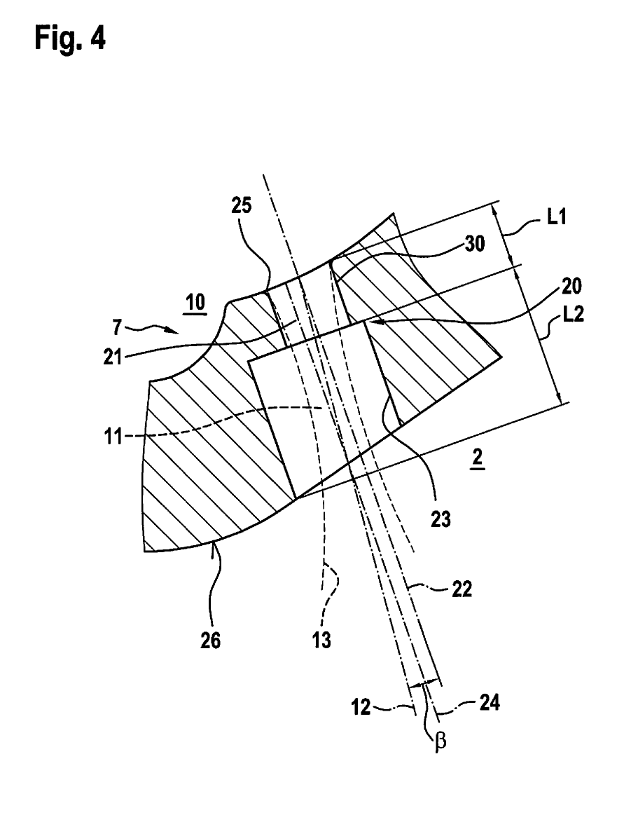

An enlarged illustration of housing 3 in the area of inflow area 7 and of through opening 20 is apparent in particular in FIG. 4. Through opening 20 includes an injection hole 21 having a first center axis 22, and a preliminary stage 23 having a second center axis 24. Fuel 10 thus flows from inflow area 7 into injection hole 21 via an inlet edge 25. Injection hole 21 opens into preliminary stage 23, through which fuel 10 exits from a dome 26 of injector 1 as a jet 11 that is disaggregated into a spray 13. The diameter of preliminary stage 23 is dimensioned to be much greater than the diameter of injection hole 21. The illustrated design of through opening 20 of injector 1 is a through opening 20 with a so-called deep, narrow preliminary stage. Length L2 of preliminary stage 23 in the flow direction is dimensioned to be greater than length L1 of injection hole 21. In addition, the diameter ratio of the areas of preliminary stage 23 to injection hole 21 through which flow passes is approximately 2:1.

A separation forms at the inlet edge 25 of injection hole 21 due to intense deflection and turbulence, resulting in the formation of a nonhomogeneous channel flow in injection hole 21 with high cavitation rates. Due to short length L1 of injection hole 21, an exiting jet 11 is not uniformly directed, so that a center axis 12 of jet 11 extends at an angle β with respect to first center axis 22, not coaxially. A uniformly directed jet 11 is present when jet axis 12 is oriented in parallel to center axis 22.

Preliminary stage 23 has a center axis 24 that is situated in parallel to and spaced apart from center axis 22 of injection hole 21. This eccentrically offset preliminary stage 23 results in a uniform distance between jet 11 and the wall of preliminary stage 23 over the preliminary stage circumference. This results in particular in a more homogeneous interaction with jet 11 over the circumference, so that the dome wetting and the penetration are reduced, and the jet separation angle is increased by the avoidance of a one-sided jet constriction at the preliminary stage wall due to a collision with same. The vortex system which forms in preliminary stage 23 and which is part of the entrainment flow results in re-aspiration of fuel 10 that is deposited on dome 26, and resupplies it to jet 11. In addition, the eccentrically offset arrangement of preliminary stage 23 with respect to injection hole 21 allows an increase in the system robustness with regard to manufacturing tolerances.

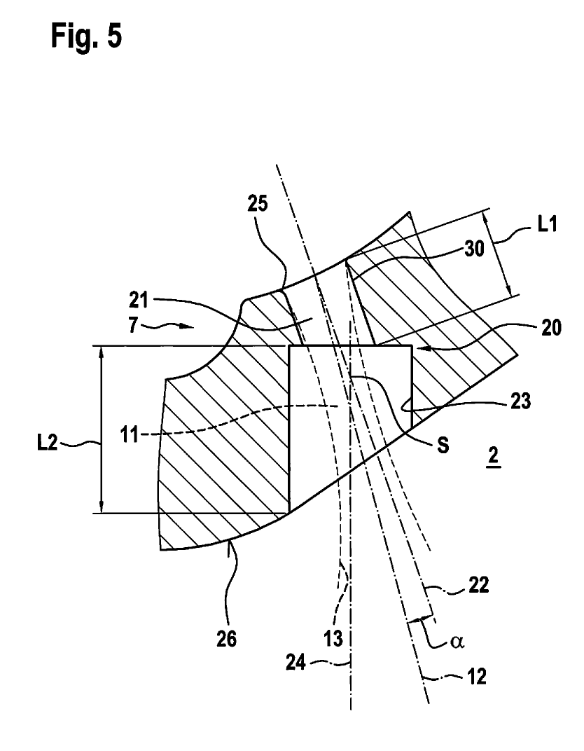

FIG. 5 illustrates a second exemplary embodiment according to the present invention. In contrast to the first exemplary embodiment, center axis 22 and center axis 24 are not oriented in parallel to one another in the second exemplary embodiment. Center axis 24 of preliminary stage 23 is oriented in parallel to jet axis 12, and is inclined at an angle α with respect to center axis 22 of injection hole 21. Jet 11 or jet axis 12 is thus coaxial and circumferentially symmetrical on center axis 24 of preliminary stage 23. To improve the jet dispersion, i.e., the spatial expansion in the radial direction of spray 13 formed by jet 11, injection hole 21 includes a divergent flow channel. The divergent flow channel thus has a continuously increasing channel cross section in the flow direction. Angle α may be in a range of 3° to 7°. An intersection point S of the two center axes 22, 24 is situated within through opening 20.

In addition, inlet edge 25 of injection hole 21 may be provided with a rounding via which the separation in injection hole 21 and the cavitation rate in the flow channel of injection hole 21 are reduced. The flow straightening effect of injection hole 21 is thus improved.

It is self-evident that injection hole 21 may have a constant, i.e., cylindrical, divergent, or convergent, channel cross section. The area ratio of the narrowest injection hole cross section to the preliminary stage cross section has values of 1:1.3 to 1:12.

The specific embodiments according to the present invention share the common feature that injection hole 21 is always situated within preliminary stage 23 at the transition into preliminary stage 23. As a result, the channel cross section in the transition from injection hole 21 into preliminary stage 23 is enlarged approximately over the entire circumference. At maximum divergence of center axes 22, 24, the circumferential surface of injection hole 21 may thus merge continuously into the circumferential surface of preliminary stage 23 at a circumferential position.

In addition, it is understood that the at least one through opening 20 is provided in housing 3 or in injection hole disk 8. Injection hole disk 8 may be fastened in a gas- and fluid-tight manner to housing 3 with a form-fit and/or force-fit connection, so that the injection hole disk partially encloses inflow area 7. Injection hole disk 8 allows simple and cost-efficient customization of injector 1.

Thus, according to the present invention an injector 1 including at least one preliminary stage 23 may be provided which has a greatly improved jet preparation, also with reduced manufacturing tolerances. Due to the central orientation of the center of mass of jet 11 in preliminary stage 23, according to the present invention the dome wetting and penetration are reduced, and the jet separation angle increases due to avoidance of a one-sided jet constriction at the preliminary stage wall. As a result of the circumferentially symmetrical flow through preliminary stage 23, the self-cleaning effect is improved due to the re-aspiration of fuel 10 deposited on dome 26 via a pronounced vortex system, and the system robustness as a whole is thus increased with regard to manufacturing tolerances.

What is claimed is:

1. An injector for injecting a fluid, comprising:
at least one closing element for opening and closing at least one through opening;
wherein the through opening includes an injection hole having a first center axis, and a preliminary stage having a second center axis, and
wherein the first center axis of the injection hole and the second center axis of the preliminary stage of at least one of the through openings diverging.

2. The injector of claim 1, wherein the first center axis is situated in parallel to and spaced apart from the second center axis.

3. The injector of claim 1, wherein the second center axis is oriented at an angle) with respect to the first center axis.

4. The injector of claim 1, wherein the second center axis intersects the first center axis within the through opening.

5. The injector of claim 1, wherein the preliminary stage is situated behind the injection hole in the flow direction through the through opening.

6. The injector of claim 1, wherein the injection hole and/or the preliminary stage has a cylindrical, divergent, or convergent flow channel.

7. The injector of claim 1, wherein the length of the injection hole in the flow direction is smaller than the length of the preliminary stage.

8. The injector of claim 1, wherein an area ratio of the smallest area of the injection hole through which flow passes to the smallest area of the preliminary stage through which flow passes is 1:1.3 to 1:12.

9. The injector of claim 1, wherein the center of mass of a jet is situated at the end of the injection hole, on the center axis of the preliminary stage.

10. The injector of claim 1, wherein the injector includes at least one flow pocket.

11. The injector of claim 1, wherein the fluid is a fuel.
